(19) United States
(12) Patent Application Publication
(10) Pub. No.: US 2010/0199720 A1
(43) Pub. Date: Aug. 12, 2010

(54) APPARATUS AND METHOD FOR PRODUCTION OF DISPLAY GLASS

(76) Inventors: Hildegard Roemer, Floersheim (DE); Stefan Schmitt, Stadecken-Elsheim (DE); Wilfried Linz, Mainz (DE); Joachim Kuester, Erzhausen (DE); Guido Raeke, Bingen (DE); Frank-Thomas Lentes, Bingen (DE); Karin Naumann, Ober-Olm (DE)

Correspondence Address: MICHAEL J. STRIKER, 103 EAST NECK ROAD, HUNTINGTON, NY, 11743, US

(21) Appl. No.: 12/704,022

(22) Filed: Feb. 11, 2010

(30) Foreign Application Priority Data
Feb. 11, 2009 (DE) 10 2009 000 785.7

(51) Int. Cl. C03B 5/00; C03B 5/18

(52) U.S. Cl. 65/134.1; 65/178

(57) ABSTRACT

The apparatus (300) for feeding, homogenizing, and conditioning a high viscosity glass melt for manufacturing display glass has a stirring device (110, 406), an upstream connecting part (100, 400) that connects the stirring device (110, 406) to an upstream melting and/or refining unit, and a downstream connecting part (120, 420) that connects the stirring device (110, 406) to a downstream forming or shaping device. Wall material and base material of the first and connecting parts and the stirring device (110, 406) coming in contact with the glass melt are made from a zirconium-dioxide-containing fire-resistant material containing a large amount, preferably more than 85 wt. %, of zirconium dioxide. A method of operating the apparatus to make display glass is also described.

### CROSS-REFERENCE

The invention described and claimed herein below is also described in German Patent Application 10 2009 000 785.7, filed Feb. 11, 2009 in Germany. The aforesaid German Patent Application, whose subject matter is incorporated herein by reference thereto, provides the basis for a claim of priority of invention for the invention claimed herein below under 35 U.S.C. 119 (a)-(d).

### BACKGROUND OF THE INVENTION

1. The Field of the invention

The present invention relates to a method of making glass, especially display glass, in which a highly viscous glass melt supplied by a melting and refining apparatus is conducted by a first connecting part to a stirring device in which it is homogenized, and then is conducted by a second connecting part to a shaping, casting, or forming device. The invention also relates to an apparatus for feeding, homogenizing, and conditioning a highly viscous glass melt for production of display glass or another glass of a high quality with a stirring device, a first connecting part upstream of the stirring device for connecting the stirring device with a melting and refining apparatus and a second connecting part downstream of the stirring device for connecting the stirring device with a shaping, casting, or forming device.

2. Description of the Related Art

The term “glass melt” in the following disclosure is understood to mean a highly viscous glass melt, whose viscosity is between about 1 and 500 Pa s. This sort of highly viscous glass melt forms a laminar flow in the apparatus on the way from the melting/refining unit to the forming, casting, or shaping device. Since the chemical diffusion coefficient is very small, typically 10⁻¹² m²/s or less, a diffusive mixing of the glass melt can be almost completely prevented. Non-uniformities or inhomogeneities in the glass melt remaining during transport to the forming or shaping unit would appear in the cross-sectional image of the glass product as a striped pattern or schlieren and/or as thickness fluctuations after drawing the glass to a very small thickness without a mechanical homogenizing by a stirring device. No special measures to avoid new bubble formation at interface areas are required for soda lime glass (float glass for automobiles or buildings), since typically up to 10 bubbles with a bubble diameter of >0.5 mm per kg of glass occur. Bubbles less than 0.5 mm diameter do not usually interfere in that application.

Both schlieren formations and bubble faults of the aforesaid size are not considered troublesome in the manufacture of flat glass with a typical thickness of 2 mm for architecture or automobile applications (e.g. windows), so that no further special measures are needed to avoid bubbles and schlieren.

The situation is different for the present application, manufacture of display glass, in which the glass sheet thickness is in a range of 2 mm or less, preferably 1 mm or less, and especially frequently 0.7 mm. This requires very high standards for formation of the display glass, which can be attained in a known way by down-draw methods, overflow fusion methods, or float bath methods. The specifications for production of display glass regarding bubble quality and purity call for less than 0.3, preferably less than 0.1, bubbles and solid inclusions per kilogram of glass in practice. The maximum allowable particle and/or bubble size is about 100 μm. The large-area thickness tolerances of the display glass are in the vicinity of 50 μm, while the small-area thickness fluctuations, also called waviness, may amount to a maximum of 400 nm, preferably a maximum of 250 nm, and especially preferably a maximum of 50 nm. The latter case is especially preferred, since then an after-polishing of the glass sheet can usually be avoided.

In order to fulfill the above-described specifications the glass melt must be very uniform not only in regard to its chemical composition, but also with respect to its viscosity, thermal expansion coefficient, and index of refraction.

For this purpose known stirring devices are provided in the glass production plant, in which the melt is circulated and non-uniformities are stretched out, redistributed, and chopped up. Typical apparatuses for homogenizing and conditioning the glass melt for manufacture of display glass are described, for example, in DE 10 2005 013 468 A1 or DE 10 2005 019 646 A1. The first connecting part between the melt/refining unit and the stirring device and also the second connecting part between the stirring device and the forming device, in this case the tweet of a float bath, are made from platinum or an alloy thereof with other noble metals (in the following simply designated as platinum) in an apparatus or a system especially for this purpose. The advantage of platinum for this application is that the system can be made practically free of joints and that no open-pored contacting surfaces exist by which bubbles can be introduced to the glass melt in contrast to construction with fire-resistant bricks. Furthermore platinum has a stable surface in comparison to brick, so that practically no corrosion of the material and thus no introduction of wall material into the glass melt and thus no change in the glass composition occur.

Especially for the above-described reasons it is possible to make a stirring device comprising a stirring vessel and stirrer made from platinum, in which only very small gaps must be maintained between the stirring blades of the stirrer and the stirring vessel or between the stirring blades of several connected stirrers arranged beside each other or in series. Because of that the stirring efficiency is very high and thus a very good uniformity of the glass melt is attained. Otherwise the shear stresses arising from the great proximity lead to increased wall material decomposition at the wall. This sort of stirring device is described, for example, in WO 2005/063633 A1 or WO 2005/040051 A1.

A melt feed unit for a glass melt of high viscosity for making display glass, which has channels made from fire-resistant material, which has surfaces that are clad with a thin platinum layer for the same reasons, is described in DE 10 2004 004 590 A1.

However the use of platinum for the surfaces coming in contact with the glass melt does not only have advantages but also disadvantages. For example, such systems only have a comparatively short service life of 1 to 2 years at temperatures greater than 1200° C., after which the entire system must be reconditioned or replaced. This is associated with plant downtime and lost output. Furthermore platinum is a very expensive material, whose cost results in increased production costs. Finally oxygen bubbles can arise on a platinum surface, which negatively impact the product quality and thus the efficiency of the manufacturing process.

### SUMMARY OF THE INVENTION

It is an object of the present invention to provide a method of manufacturing display glass of a high quality economically.

This object and others, which will be made more apparent hereinafter, are attained in a method of manufacturing glass, especially display glass, wherein a highly viscous glass melt is conducted from a melting and/or refining unit by a first connecting part to a stirring device, homogenized there, and conducted from the stirring device by a second connecting part to a forming or shaping device.

According to the invention the method includes forming the wall material and the base material of the first and second connecting parts, which come in contact with the glass melt, from a zirconium-dioxide-containing fire-resistant material, which contains a large amount of zirconium dioxide.

The object of the invention and others, which will be made more apparent hereinafter, are also attained in an apparatus for feeding, homogenizing, and conditioning a highly viscous glass melt in order to manufacture glass, especially display glass, with a stirring device, a first connecting part upstream of the stirring device for connecting the stirring device to a melting and/or refining unit and a second connecting part downstream of the stirring device for connecting the stirring device with a forming or shaping device.

According to the invention the wall material and the base material of the first connecting part, of the stirring device, and of the second connecting part that come in contact with the glass melt comprise a zirconium-dioxide-containing fire-resistant material, which contains a large amount of zirconium dioxide.

It was discovered that the use of the aforesaid materials for the parts of the wall and base and the sections of the connecting parts and of the stirring device, which come into contact with the glass melt, provides a sufficiently high resistance to crack formation, spalling, and wear or erosion, in the effective regions of the stirrer, in order to attain good homogenization of the glass melt. The materials can be made nearly free of thermally induced stresses and dissolve in the melt without introducing particles. Thus these materials are basically suitable for use in the homogenization and conditioning of a highly viscose glass melt for making display glass with direct contact to the glass melt.

Zirconium-dioxide containing fire-resistant material with a high content of zirconia is, for example, described in EP 0 403 387 B1, EP 0 431 445 B1, U.S. Pat. No. 5,023,218 B, DE 43 20 552 A1, or DE 44 03 161 B4. However the main point of these developments is the resistance to very high melt temperatures with respect to corrosion resistance and crack formation behavior and a high specific electrical resistance. The material thus was recommended for building melt furnaces, especially for high melting glass compositions. The temperatures occurring in the homogenization region are considerably lower so that the chemical corrosion is considerably reduced. However it has been shown that zirconium-dioxide containing fire-resistant material with a high content of zirconium dioxide (ZrO₂) also has a high resistance to mechanically dependent corrosion, especially to wall shear stresses at these temperatures. It is generally critical with fire-resistant material that dissolution of particles of the wall/base material, which can be found in the product and lead to loss of product, can occur with wall shear stresses that are too large. This is illustrated in the comparison of the maximum values of the wall shear stresses, at which the various materials can function without decomposition or destruction, according to the appended FIG. 8. Zirconium-dioxide containing fire-resistant material with a high content of zirconium dioxide (ZrO₂) (bars 1 to 4 of appended FIG. 8) in contrast to commercially obtainable fire-resistant material, which withstands wall shear stresses up to about 300 Pa, may withstand wall shear stresses up to 1000 Pa. Thus the maximum shear stress resistance of this latter material approaches the maximum wall shear stress resistance of glass conducting surfaces clad with noble metal, which bear those shear stresses without decomposing (bars 5 to 7 of FIG. 8).

This observation led to the cladding of wall and base sections, especially of the stirring device, and also the first and second connecting parts, i.e. at places at which no especially high melt temperatures, but extraordinary mechanical stresses, are present, for which these wall materials were not originally conceived, with zirconium-dioxide containing fire-resistant material containing large amounts of zirconium dioxide (ZrO₂).

Since materials such as platinum are very expensive, the present invention provides a cost-saving alternative for construction of the apparatus for feeding, homogenization, and conditioning of a highly viscous glass melt and thus an economical method for making display glass. Essentially the wording “zirconium-dioxide containing fire-resistant material with a high content of zirconium dioxide” in the sense of the present invention means that the glass melt primarily or completely contacts the zirconium-dioxide containing fire-resistant material in the connecting parts and the stirring device. A cladding, especially comprising platinum, can be provided only in small (as measured in comparison to the total area contacted by the glass melt), especially strongly stressed sections or in sections where a direct heating is required. It is decisive and critical for the invention that the predominant part of the wall sections coming in contact with the glass melt are formed from fire-resistant material, in order to be able to provide the aforesaid advantages.

The aforesaid suitability is especially present when the wall material and base material has one or more of the following characteristics.

Basically a zirconium-dioxide containing densely sintered pore-free material can be provided for the application according to the invention. A melt-cast fire-resistant material with a glassy phase is particularly preferred for the wall material and the base material.

In contrast to sintered fire-resistant material the aforesaid material is not open-pored and thus not gas permeable, which leads to new bubble formation in the melt.

Preferably the zirconium-dioxide containing fire-resistant material contains more than 85 wt. % of zirconium dioxide (ZrO₂), especially preferably more than 90 wt. % of zirconium dioxide. It also contains Al₂O₃ and SiO₂. It contains small amounts of alkali metals, e.g. as oxides, such as Na₂O, and/or alkaline earth metals, e.g. as oxides, such as CaO or BaO.

In an especially preferred embodiment of the apparatus the walls and/or the base of the first connecting part, of the stirring device, and of the second connecting part, which come into contact with the glass melt, are made from a layer of blocks of fire-resistant material with an insulating layer on the side of the blocks facing away from the glass melt. The insulating layer is made of individual pieces or elements with intervening joints, which cover or coincide with the joints between the blocks of the fire-resistant material. It is preferable when the joints of the insulating material are larger than the joints of the fire-resistant material.

In conventional construction insulation is deposited under the blocks of fire-resistant material without considering the positions of the blocks. This has the consequence that the glass melt can seep through the joints between the blocks of fire-resistant material and come into contact with the insulation underneath the blocks. Bubbles, which rise through the joints and into the melt and impair the quality of the product, form at the places where the melt contacts the insulation. This has an especially negative effect on the product quality, when the faults occur in the glass melt flow downstream of the stirring device, also in the vicinity of the second connecting part. In contrast the embodiments of the claimed invention, which are joint-free, i.e. in which the insulation is not under the joints between the blocks of fire-resistant material, prevent contact of the glass melt with the insulation. The lack of insulating material under the joints is taken care of in that the melt already solidifies between the blocks of fire-resistant material so that no melt can flow through the joints. The system seals itself at the crucial points before the melt can come into contact with any other material besides the fire-resistant material. Furthermore the melt does not come into contact with the insulating material even when it solidifies at the outer end of the joints, because no insulating material lies under the joints. The cooling action of the glass contact material joints and the prevention of contact of the glass melt with the insulating material are guaranteed, especially when the joints of the insulating material are somewhat wider than the joints between the fire-resistant blocks.

According to an alternative solution of the aforesaid problems the base and/or walls of the first connecting part, of the stirring device, and of the second connecting part, which come into contact with the glass melt, comprise at least two layers of blocks of fire-resistant material, in which the respective joints of the corresponding layers of the blocks are displaced or offset in relation to each other.

In this alternative embodiment the path of the melt through the joints is so great that the solidification of the melt before reaching the rear wall of the fire-resistant material and thus the insulating material is guaranteed by the displacement of the respective joints in the corresponding layers of the fire-resistant blocks. Furthermore even when the glass melt penetrates to the insulating material and forms bubbles there, these bubbles cannot rise directly into the glass melt.

Preferably the stirring device has at least one stirrer comprising a stirrer shaft arranged transversely to the throughput flow direction through the first and second connecting part and at least one stirrer blade connected with the stirrer shaft, which is equipped to attain an axial feed of the melt in the interior region of the stirring device, which is greater than the throughput flow of melt from the first to the second connecting part.

Especially it has proven to be advantageous when a sufficiently large gap is formed between the stirrer blades and the vessel wall and between the stirrer blades and the base so that the shear stresses produced at the wall and the base do not exceed a value of 1000 Pa, especially preferably 550 Pa, considering the nominal rotation speed of the stirrer blades and the viscosity of the glass melt.

This may produce clearly improved homogenizing action of the stirring device in comparison to that of the prior art because of the use according to the invention of the above-described stirrer due to its higher transverse flow in its interior region and the circumferential backflow transverse to the throughput flow, which the transverse glass melt flow in the stirring direction blocks.

An additional improvement of the homogenization results from an increase in the average dwell time of the glass melt in the stirring system. This can be achieved by dimensional enlargement of the stirring system while maintaining the above-described flow ratios, mass throughput, density, and viscosity of the glass melt and the stirring speed at the given maximum shear stress.

Stirring devices of the above-described type are known from DE 10 2006 060 972 A1. According to the principles of operation of this stirring device the flow of the glass melt is guided in the stirring device and of course is of a size so that the feed rate of the glass melt by the stirrer is greater than the flow rate of the glass melt through the entire apparatus from the melting/refining unit to the forming device. The gap between the stirrer blades and the base and/or the wall facilitates a backflow in the outer gap region that is opposite to the axial feed direction of the melt and similarly transverse to the direction of the through-going flow, which blocks direct throughput flow of the glass melt past the stirrers. Thus even without the use of a stirring vessel with small gap dimensions the entire glass melt flow can be guaranteed to circulate through the stirring process at least once. The stirring device effectively forms a virtual stirring vessel. At the same time the comparatively large gap width facilitates the use of fire-resistant brick as the wall and base material for the stirring device, since the wall shear stresses can be considerably reduced because of the larger distance between the stirrer blades and the wall or the stirrer blades and the base.

Especially the process according to the invention can be designed, so that the blocking or sealing is set up at a rotation speed of the stirrer of 5 rpm or more. Thus the combination of the zirconium dioxide-containing fire-resistant material with a high content of zirconium dioxide for the stirring vessel and the above-described stirring process guarantees in a two-fold manner that the apparatus according to the invention provides a sufficiently good homogenization of the glass melt without increased danger of material inclusions.

Furthermore it is preferable when a base outlet is arranged under the stirrer.

Impure glass melt can be removed from the stirring section through the base outlet. The term “impure glass melt” means a glass melt with a higher density, another composition. or even with foreign particles, for example with components resulting from erosion of the fire-resistant material. That the glass melt flow can be guaranteed in the melting/refining unit even when the hot forming process steps are stopped (e.g. on account of replacement of the spout or the tweel or other elements of the float bath) is an additional advantage of the base outlet. Thus the melting/refining process would remain undisturbed, even when the hot forming process is interrupted. It is easy to again start the entire glass melt flow, because the glass melt continues to flow to the second stirring section and there are no “frozen” locations. The base outlet is preferably arranged centrally under the stirrer. Additionally it is advantageous to lower the base level at the bottom outlet so that the melt and the residue can reach the outlet without difficulty.

The danger of material erosion or wear of the fire-resistant material can be still further reduced when the blocks of the fire-resistant material are arranged during construction of the wall and/or the base so that they form no joints in the region of closest approach of the stirrer blades to the wall and/or the base where there would be an increased danger of crack formation and spalling due to the action of increased stresses on the edges of any blocks that are located there.

The use of platinum or other noble metals, even in the vicinity of the stirrers of the aforesaid stirring device, can be avoided when the above-described measures are maintained.

In order to obtain the axial feed of melt in the stirrer, the stirrer blades are preferably inclined to the rotation plane of the stirrer shaft. The inclined orientation of the blades and their geometric arrangement along the sitter shaft can be determined and optimized by physical and mathematical simulation.

The stirring device can have at least two stirrers arranged in series following each other in the direction of the throughput flow or at least two stirrers arranged beside each other transverse to the direction of the throughput flow in order to increase the stirring device efficiency. Especially in the latter arrangement one must take care that the total axial feed action is greater than the throughput flow through the apparatus.

The inner region of the stirring device in the sense of the aforesaid measures means the region that is predominantly radially within the cylindrical peripheral surface generated by the motion of the stirrer blade ends, which is also close to the stirrer shaft. The outer region of the stirring device in the sense of the aforesaid measures means the region that is predominantly outside of the cylindrical peripheral surface generated by the motion of the stirrer blade ends.

It is preferably when at least one barrier element is arranged along the wall and/or the base of the stirring device and/or of the first connecting part and/or of the second connecting part in the area surrounding the stirrer.

The phrase “the area surrounding the stirrer” means a region between or after the stirrer or stirrers in which the arrangement is selected so that the blocking by the stirrer is improved and thus the glass melt is kept in the stirring device for a longer time interval.

The stirring device efficiency is further optimized when the wall of the stirring device forms a stirring vessel at least approximately concentrically surrounding a peripheral section of the stirrer.

Although two parallel walls forming their own virtual stirring vessel can guarantee an effective stirring action because of the properties of the stirring device, the blocking action of the backflow of the glass melt can be especially increased, when the wall at least approximately follows the cylindrical peripheral surface generated by the motion of the stirrer blade ends.

The base area of the stirring vessel is preferably polygonal and is particularly preferably hexagonal or octagonal.

Especially an octagonal base area is a sufficiently close approximate to the cylindrical shape. A polygonal shape is generally easier to make with the blocks of fire-resistant material in contrast to embodiments with a circular cross-sectional area.

Preferably the apparatus has a spout made from fire-resistant material, which connects directly downstream to the second connecting part.

The homogenized melt is among other things conditioned in the second connecting part, which means adjusted (cooled) to the temperature at which it is supplied to the following shaping or forming process. Thus the second connecting apparatus is preferably constructed as an oven or covered channel, which can be heated with a heating device, e.g. with burners, radiant heaters, or a heatable roof and can be cooled by variable insulation, so that the temperature can be controlled as precisely as possible.

Furthermore an overflow with a skimmer, for example in the form of a stone or platinum plate, which is arranged in the melt so that it is oriented transversely to the flow direction, can be provided at the end of the connecting part. The skimmer operates to draw off a surface glass layer of a different composition from the bulk of the glass melt, which is formed by evaporation of ingredients of the melt (e.g. boron).

The evaporation can be further limited or reduced by means of gas injection in the region of the second connecting part, by which boron-containing gases are injected or sprayed into the chamber over the glass melt in the above-described example, so that evaporation products are maintained in a high concentration in the furnace chamber or generally an inert atmosphere is produced over the glass melt, which minimizes the formation of a surface layer with changed composition.

The means for gas injection are preferably formed so that only a small glass flow is formed over the glass melt, so that the evaporation of easily volatilized glass components and thus the danger of formation of a heavy viscous surface layer is reduced as much as possible. The drawing off of the surface layer can be eliminated if such layer formation can be avoided. When the formation of a heavy viscous surface layer cannot be avoided, the combination of the above-described overflow and an optional skimmer at the end of the channel prior to the spout should be considered.

The above-described considerations also apply to heating with a fossil fuel burner. These burners are formed in an advantageous manner so that the required volume of the fuel and/or the product exhaust gas is as small as possible. An optimized energy design is important for correct supply of the burner, which means that the heating device is required to supply so much energy that during normal operation a minimum supply of the burner is required to guarantee control or regulation of the glass temperature. Furthermore the flow speed at the burner outlet and thus the exhaust gas flow speed on the glass surface are minimized by formation and placement of the burner and especially the burner nozzle.

The second connecting part is preferably as short as possible while maintaining the reliability of the processing. That means that the distance from the stirring device to the forming apparatus, for example to a tweel, is selected so that it is just so long that the glass temperature required for the forming can be reliably reached. The length of the second connecting part depends on the throughput, the temperature differences, and the heat capacity of the glass melt. In the process according to the invention a preferred heat loss is about 25 kW per unit length of the connecting part. A length of the second connecting part of preferably less than 5 m and especially preferably less than 4 m results from that with a daily throughput of about 50 tons. A lower limit of the length is preferably about 2 m and especially preferably 2.7 m with a daily throughput of about 50 tons. The minimum lengths increase with a higher throughput. Basically with a typical heat capacity cₚ of about 1450 J/kg-° K. the minimum structure length L depending on the required or desired heat loss ΔT and the throughput is: L=6.75*10⁻⁴ m per ° K. and per ton/day of throughput.

The danger of the formation of a surface layer with changed composition and likewise the danger that new bubbles will form after homogenizing is kept as small as possible with such short embodiments of the second connecting part. Furthermore because of these features the stirring device is closer to the forming or shaping apparatus, which means that lower temperatures exist in one section of the apparatus. That is advantageous since the danger of dissolving or spalling of fire-resistant material due to a combined energy and mechanical strain.

### BRIEF DESCRIPTION OF THE DRAWING

The objects, features and advantages of the invention will now be illustrated in more detail with the aid of the following description of the preferred embodiments, with reference to the accompanying figures in which:

FIG. 1 is a schematic longitudinal cross-sectional view through an apparatus according to the invention;

FIG. 2 is a schematic side view of a stirring device of the apparatus according to the invention with stirring elements arranged following each other in the flow direction for illustration of a working stirring device;

FIGS. 3a and 3b are, respectively, a diagrammatic side view and a top view of a first embodiment of the apparatus according to the invention with a first stirring vessel geometry;

FIGS. 4a and 4b are, respectively, a diagrammatic side view and a top view of a second embodiment of the apparatus according to the invention with a second stirring vessel geometry;

FIGS. 5a and 5b are, respectively, a diagrammatic side view and a top view of a third embodiment of the apparatus according to the invention with third stirring vessel geometry;

FIGS. 6a and 6b are, respectively, a diagrammatic plan view and a side view of a portion of a first embodiment of a base of the apparatus according to the invention;

FIGS. 7a and 7b are, respectively, a diagrammatic plan view and a side view of a portion of a second embodiment of a base of the apparatus according to the invention; and

FIG. 8 is a bar graph showing the wall shear stress for different wall and/or base materials of different stirring devices.

### DESCRIPTION OF THE PREFERRED EMBODIMENTS

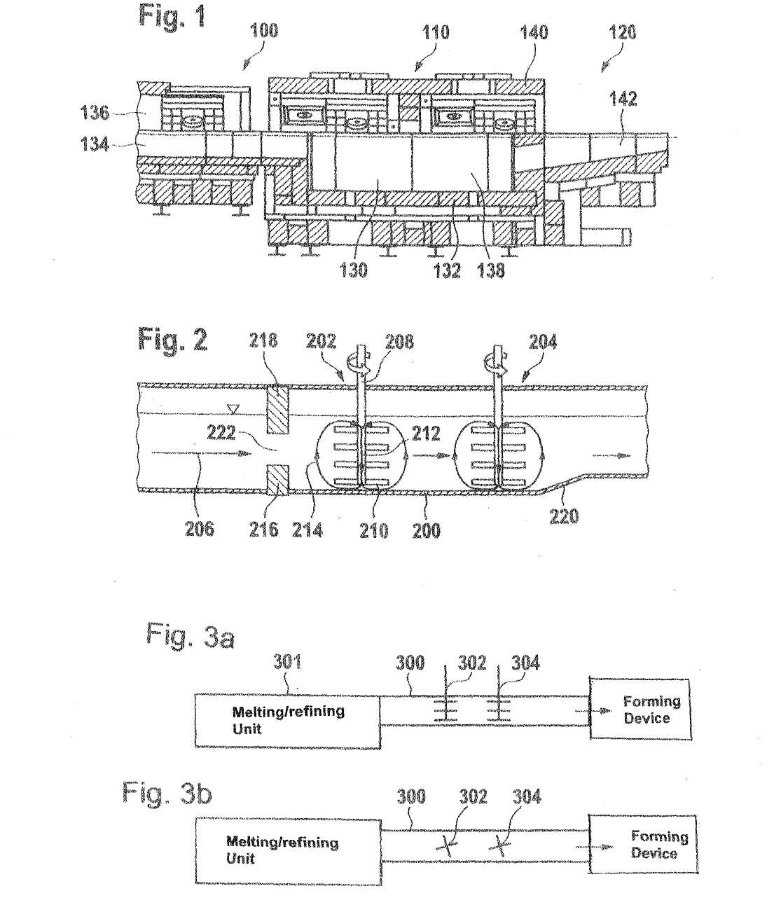

The apparatus according to the invention shown in FIG. 1 has a first connecting part 100, a downstream stirring device 110 connected to it, and a second connecting part 120 connected to the downstream side of the stirring device 110. The first connecting part 100 connects the stirring device 110 with an upstream melting and/or refining unit from which the glass melt flows, which is not shown in the illustrated embodiment. The second connecting part 120 connects the stirring device 110 with a connected downstream forming, casting, or shaping device, for example, a float bath, an overflow fusion unit, or a down-drawing unit. The first connecting part 100, the stirring device 110, and the second connecting part 120 have respective walls 130 and bases 132, which are made from blocks of a zirconium oxide-containing fire resistant material with a large zirconium content.

The first connecting part 100 comprises a channel or duct 134 with a roof or a vault 136. The vault 136 covers an upper furnace over the glass melt. The stirring device 110 comprises a stirring vessel 138 and another vault 140 arranged over the glass melt. In the vault 140 diverse openings are provided for guidance of stirring shafts and for installation of burners in an upper furnace chamber. The second connecting part 120 is formed by a channel 142, which is not covered in the illustrated embodiment. Understandably the apparatus can be designed so that the entire apparatus is covered completely by one or more vault arrangements.

In FIG. 2 the action of the stirring device is schematically illustrated in a simplified form. The stirring device 110 comprises a stirring vessel 200, in which two stirrers 202 and 204 are arranged in series or following each other in the direction of the flow of the glass melt indicated with the arrow 206. Each stirrer 202 or 204 has a stirrer shaft 208 and several stirrer blades 210, which produce an axially downward feed in the inner region of the stirring device, i.e. predominantly within the stirrer blade ends in a radial direction, indicated by the arrow 212, by rotation of the stirrer. This downwards directed mass flow is larger than the throughput flow of the glass melt in the direction of the arrow 206, which is perpendicular to it. Similarly a backflow 214 resulting from that, which is outside of the ends of the stirrer blades, i.e. in the outer region, is also perpendicular to the mass flow 206. The backflow 214 substantially seals the stirrer 202 or 204 opposite to the walls and the base of the stirring vessel 200. In this way the melt cannot directly pass by the stirring device, but must flow through each stirrer 202 or 204 at least once.

The aforesaid effect is assisted further by barrier elements 216, 218, and 220, which are arranged along the walls and the base of the stirring device and/or in their transitional regions to the first and second connecting parts before and after the stirrers 202 and 204. The barrier element 216 is a wall element, which is placed between the first connecting part and the stirring vessel 200 so that it is perpendicular to the melt flow direction 206 on the bottom side of the transitional region. The wall-shaped barrier element 218 engages in the flow of the melt from above, i.e. from the roof side, at the same position as the barrier element 216. There is a gap 222, which defines a narrow entrance cross-section to the stirring vessel 200, between the barrier elements 216 and 218. The barrier element 220 is formed as a ramp-shaped inclined portion of the base of the stirring vessel 200 at its outlet end.

Alternative embodiments of the apparatus of the invention are shown in the side views and top views of FIGS. 3a, 3b; 4a, 4b; 5a, 5b respectively. According to FIGS. 3a and 3b, which shows the simplest embodiment, the first connecting part for connection to an upstream refining/melting unit 301 and the second connecting part for connection with a downstream forming or shaping device are formed by a duct or channel 300 with a constant cross-sectional area, so that a boundary or transition between the first connecting part, the stirring device, and the second connecting part is not defined or provided by structural elements of the apparatus. The stirring device comprises the stirrers 302, 304, which form their own virtual stirring vessel within the duct 300 in the manner described previously in connection with FIG. 2. Furthermore it is only necessary to guarantee that the wall- and base-spacing of the stirring blades is chosen small enough, taking into account the desired cross-flow produced with the stirrers 302, 304 so that prevention to a direct flow past the stirring device.

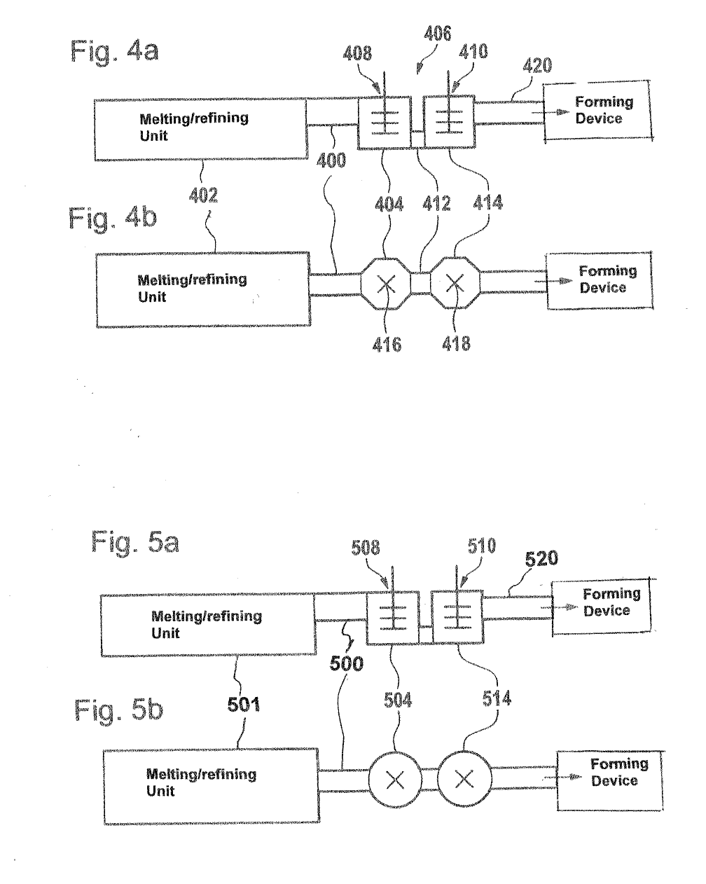

The embodiment according to FIGS. 4a and 4b has a first connecting part 400 between the refining and/or melting vessel 402 and a first stirring vessel 404 of the stirring device 406 for conducting the glass melt from the refining or melting vessel 402. The stirring device 406 comprises a first stirrer 408 and a second stirrer 410, which are connected with each other by a bottom-side connecting duct 412. Both stirrers have their own separate stirring vessels 404 and 414 respectively, which have octagonal base cross-sectional areas, which is apparent from the plan view shown in FIG. 4b. The stirrers 408 and 410 are each arranged in the center of their respective stirring vessels so that the stirrer blades 416, 418 maintain an at least approximately uniform distance to the walls of the stirring vessels 404 and 414. This guarantees that the backflows 214 described in connection with FIG. 2 effectively prevent a direct passage of the glass melt by the stirring device 406 without sufficient stirring.

The direct passage is further impeded or hindered, since the outlet of the first stirring vessel 404 in the form of a connecting duct 412 is below the inlet of the first stirring vessel 404 in the form of the first connecting element 400. In the case of the second stirring vessel 414 the reverse is true: its outlet is above its inlet. The passage of the glass melt through both stirrers 408 and 410 without having to circulate at least once through the stirring vessels 404, 414 and thus to be homogenized can be nearly completely prevented by correct selection of the feed direction of the stirrers 408 and 410 and/or the direction of the backflows.

The apparatus according to the invention shown in FIGS. 5a and 5b differs from that shown in FIGS. 4a and 4b only in that the stirring vessels 504 and 515 have a respective circular cross-sectional area. The previous description for the embodiment shown in FIGS. 4a and 4b otherwise applies even more to this embodiment, since the shape of the stirring vessels 504 and 514 is ideally adjusted to the circulatory motion of the stirring blades of the stirrers 508 and 510.

While the embodiments according to FIGS. 1, 4a, 4b, 5a and 5b have sunken stirring vessels in relation to the first and second connecting parts, the stirring vessels of the embodiments according to FIG. 2 and FIGS. 3a and 3b are not or only partially lower than the connecting parts connected to them. Besides the previously described formation of virtual stirring vessels a sinking of the stirring vessels improves a run off of impure glass melt through the preferably central bottom outlet, which is not shown in the embodiments illustrated in those figures.

Other embodiments, which are not shown in the drawing, differ from the embodiments shown in FIGS. 1 to 5b, because they have only one or more than two stirrers in the stirring device.

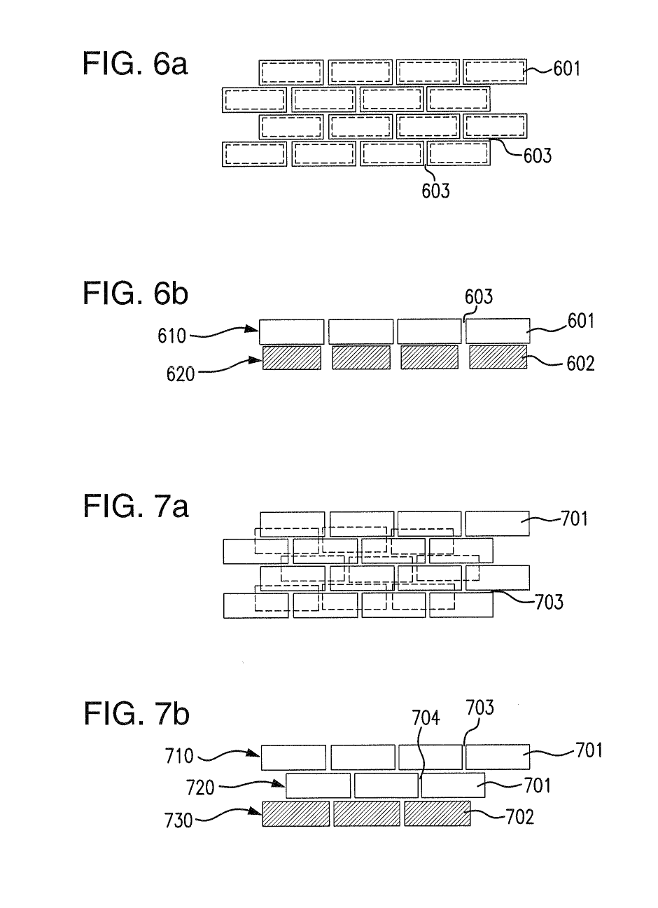

FIGS. 6a and 6b are plan and side views of the structure of the base in the stirring device of one embodiment of the apparatus of the invention. Understandably this sort of construction can also be provided in the first connecting part and the second connecting part and even for the wall structure. The base is formed from a layer 610 of blocks 601 comprising a zirconium-dioxide-containing fire-resistant material, which has a large content of zirconium dioxide, which comes in contact on its upper side with the glass melt. An insulating layer 620, which is formed from individual elements or pieces 602, is located on the underside of the blocks, also on the side of the blocks facing away from the glass melt. The individual elements 602 of the insulating layer and the blocks made of fire-resistant material cover about the same base surface area and are arranged so that all joints between the adjacent blocks 601 coincide with or cover all joints between adjacent individual elements 602. In other words all joints 603 are formed so that they are through-going from the upper side of the fire-resistant layer 610 to the lower side of the insulating layer 620. The through-going joints have the consequence that the glass melt can seep through between the joints of the blocks 601 at least until it solidifies because its temperature drops. This solidification process occurs under the joints between the blocks 601 because of the lack of insulating material very much earlier, so that it is guaranteed that no liquid melt can reach the lower ends of the joints 603 between the blocks 601. The individual elements or pieces 602 of the insulating layer 620 are constructed somewhat smaller than the corresponding blocks 601, so that the above-described effect is guaranteed even with construction inaccuracies.

Another solution of this problem is set forth in the embodiment shown in FIGS. 7a and 7b. Here the base construction of the apparatus according to the invention in the stirring device is shown in the side view according to FIG. 7b. Generally according to this embodiment the base coming in contact with the glass melt comprises two adjacent layers of blocks 701 of a zirconium-dioxide-containing fire-resistant material, which has a large content of zirconium dioxide. The blocks of the adjacent layers are arranged in both orthogonal directions in the plane of the base with either all joints offset or displaced with respect to each other. The layer 710 is the layer that comes into direct contact with the glass melt. The glass melt seeps through the joints 703 of the upper layer 710. It is largely held or guided around the blocks 701 and the lower layer 720 of zirconium-dioxide-containing fire-resistant material. Thus the path of the glass melt through the joints continues until at an insulating layer 730 formed by elements 702 so that solidification of the melt is guaranteed before it reaches this insulating layer. A vertical flow through the layers 710 and 720 only develops in unavoidable areas of overlap of the joints 703 of the upper layer 710 and the joints 704 of the lower layer 720. However the total length of the path of the melt flow in these areas is so long that the melt cannot reach the rear side of the wall of the fire-resistant material and thus the underlying insulation layer.

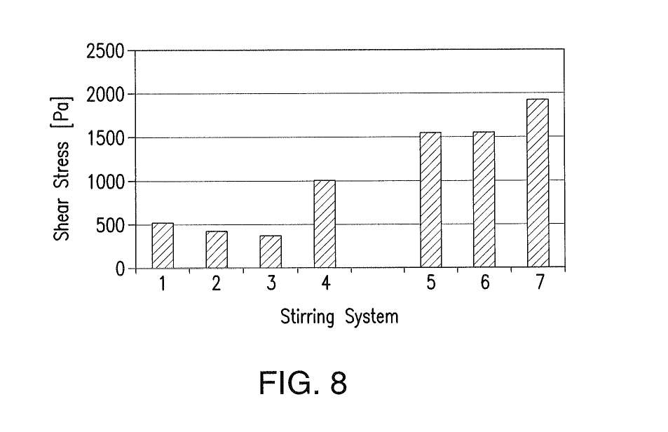

The maximum values of the wall shear stresses for four stirrer parts made from zirconium-dioxide-containing fire-resistant material, which has a large content of zirconium dioxide (bars 1 to 4), and for three stirrer parts made from platinum (bars 5 to 7) are illustrated in the bar graph according to FIG. 8. While absolutely no particles of fire-resistant material are found in the glass product made during experiments with the apparatus whose shear stresses are illustrated with bars 1, 2 and 3, isolated first particles of fire-resistant material could be detected in the glass product made during experiments with the apparatus whose shear stresses is shown with bar 4. The limiting value for the maximum wall shear stresses in the stirring devices according to the invention was determined to be about 1000 Pa. Considerably higher wall stresses were produced in experiments with platinum stirring vessels, but no glass quality impairment could be detected because of the considerably higher surface resistance of the noble material.

The term “large amount” of zirconium dioxide in the appended claims means an amount that is sufficient to attain the object of the invention, which is to economically make a display glass that is of a high quality.

### PARTS LIST

100 first connecting part
110 stirring device
120 second connecting part
130 wall
132 base
134 duct or channel
136 roof or vault
138 stirring vessel
140 roof or vault
142 channel
200 stirring vessel
202 stirrer
204 stirrer
206 throughput flow direction
208 stirrer shaft
210 stirrer blade
212 axial feed of the stirrer
214 backflow of the stirrer
216 barrier element in the form of a wall
218 barrier element in the form of a wall
220 barrier element in the form of a ramp
300 apparatus for supplying, homogenizing and conditioning
301 melting and/or refining unit
302 stirrer
304 stirrer
400 first connecting part
402 melting and/or refining unit
404 stirring vessel
406 stirring direction
408 stirrer
410 stirrer
412 connecting duct
414 stirring vessel
416 stirrer blade
418 stirrer blade
420 second connecting part
500 first connecting part
501 melting and/or refining unit
504 stirring vessel
508 stirrer
510 stirrer
514 stirring vessel
520 second connecting part
601 blocks of fire-resistant material
602 individual pieces or elements of insulation
603 joint
610 fire-resistant layer
620 insulating layer
701 blocks of fire-resistant material
702 individual pieces or elements of insulation
703 joint
704 joint
710 first layer of fire-resistant material
720 second layer of fire-resistant material
730 insulation or insulating material

While the invention has been illustrated and described as embodied in an apparatus and method for production of display glass, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

We claim:

1. A method of manufacturing glass, especially display glass, in which a highly viscous glass melt is conducted from a melting and/or refining unit by a first connecting part to a stirring device, homogenized in the stirring device, and is conducted from the stirring device by a second connecting part to a forming or shaping device;
wherein wall material and base material of the first connecting part and of the second connecting part, which come in contact with the glass melt, are made from a zirconium-dioxide-containing fire-resistant material containing a large amount of zirconium dioxide.

2. The method as defined in claim 1, wherein said fire-resistant material is melt cast and has a glassy phase.

3. The method as defined in claim 1, wherein said fire-resistant material contains more than 85 wt. % of said zirconium dioxide.

4. The method as defined in claim 1, wherein said fire-resistant material contains more than 90 wt. % of said zirconium dioxide.

5. The method as defined in claim 1, wherein said fire-resistant material comprises Al₂O₃ and SiO₂ and small amounts of alkali metals and alkaline earth metals.

6. The method as defined in claim 1, further comprising forming a wall (130) and/or a base (132) of the first connecting part (100, 400), of a stirring device (110, 406), and/or of the second connecting part (120, 420), said wall and/or said base comprising a layer of blocks of said fire-resistant material (601) with an insulating layer (730) on a side of said blocks facing away from the glass melt, and wherein said insulating layer (730) comprises individual pieces with intervening joints (603, 703, 704), which cover or coincide with joints between said blocks of said fire-resistant material (601).

7. The method as defined in claim 1, further comprising forming a wall (130) and/or a base (132) of the first connecting part (100, 400), of a stirring device (140, 406), and/or of the second connecting part (120, 420), said wall and/or said base comprising at least two layers of blocks of said fire-resistant material (601, 701), in which joints between said blocks in said two layers of said blocks are offset with respect to each other.

8. The method as defined in claim 1, further comprising providing a glass melt flow transverse to a throughput flow (206) in an interior region of the stirring device (110, 406) by operation of at least one stirrer (202, 204; 302, 304; 408, 410; 508, 510) of the stirring device, which is greater than the throughput flow.

9. The method as defined in claim 8, in which a shear stress produced at a wall (130) and a base (132) of the stirring device (110, 405) by the feeding of the glass melt in the stirring device (110, 405) does not exceed 1000 Pa.

10. The method as defined in claim 8, wherein the shear stress does not exceed 550 Pa.

11. The method as defined in claim 9, in which a peripheral backflow transverse to the throughput flow (206) is formed in an outer region of the stirring device (110, 406) due to the glass melt flow transverse to the throughput flow (206) in the interior region of the stirring device (110, 406) so that the peripheral backflow blocks glass melt flow past the stirring device (110, 406).

12. The method as defined in claim 11, further comprising rotating said at least one stirrer (202, 204; 302, 304; 408, 410; 508, 510) with a rotation speed of 5 rpm or more in operation thereof during blocking of the glass melt flow past the stirring device (110, 406).

13. The method as defined in claim 1, in which a flat glass is produced with a bubble number of less than 0.3 per kg of the flat glass, a thickness fluctuation of at most 50 μm, and a waviness of at most 400 μm.

14. The method as defined in claim 1, in which the bubble number is less than 0.1 per kg of the flat glass or the waviness is at most 250 μm or 50 μm.

15. An apparatus (300) for feeding, homogenizing, and conditioning a high viscosity glass melt for manufacturing glass, especially display glass, with a stirring device (110, 406), a first connecting part (100, 400) upstream of the stirring device (110, 406) that connects the stirring device (110, 406) to a melting and/or refining unit, and a second connecting part (120, 420) downstream of the stirring device (110, 406) that connects the stirring device (110, 406) to a forming or shaping device;
wherein wall material and base material of the first connecting part (100, 400), of the stirring device (110, 406), and of the second connecting part (120, 420) coming in contact with the glass melt comprises a zirconium-dioxide-containing fire-resistant material containing a large amount of zirconium dioxide.

16. The apparatus as defined in claim 15, wherein said fire-resistant material is melt cast and has a glassy phase.

17. The apparatus as defined in claim 15, wherein said fire-resistant material contains more than 85 wt. % of said zirconium dioxide.

18. The apparatus as defined in claim 15, wherein said fire-resistant material contains more than 90 wt. % of said zirconium dioxide.

19. The apparatus as defined in claim 15, wherein said fire-resistant material comprises Al₂O₃ and SiO₂ and small amounts of alkali metals and alkaline earth metals.

20. The apparatus as defined in claim 15, further comprising a wall (130) and/or a base (132) of the first connecting part (100, 400), of a stirring device (110, 406), and/or of the second connecting part (120, 420), and wherein said wall (130) and/or said base (132) comprises a layer of blocks of said fire-resistant material (601) with an insulating layer (730) on a side of said blocks facing away from the glass melt, and said insulating layer (730) comprises individual pieces with intervening joints (603, 703, 704), which cover or coincide with joints between said blocks of said fire-resistant material (601).

21. The method as defined in claim 15, further comprising a wall (130) and/or a base (132) of the first connecting part (100, 400), of a stirring device (140, 406), and/or of the second connecting part (120, 420), and wherein said wall (130) and/or said base (132) comprise at least two layers of blocks of said fire-resistant material (601, 701), in which joints between said blocks in said two layers of said blocks are offset with respect to each other.

22. The apparatus as defined in claim 15, wherein the stirring device (110, 406) comprises at least one stirrer (202, 204; 302, 304; 408, 410; 508, 510) and said at least one stirrer comprises a stirrer shaft (208) and at least one stirrer blade (21) connected with the stirrer shaft, said stirrer shaft is arranged transverse to a throughput flow (206) of the glass melt through the first connecting part (120) and the second connecting part (420), so that an axial glass melt flow is attained in an interior region of the stirring device (110, 406) that is greater than the throughput flow (206).

23. The apparatus as defined in claim 22, further comprising a wall (130) and/or a base (132) of the first connecting part (100, 400), of a stirring device (140, 406), and/or of the second connecting part (120, 420), and wherein a sufficiently large gap is formed between the at least one stirrer blade (210) and the wall (130) and the base (132) so that shear stresses generated at the wall (130) and the base (132) depending on a nominal peripheral speed of the at least one stirrer blade (210) and a viscosity of the glass melt do not exceed 1000 Pa.

24. The apparatus as defined in claim 23, wherein the shear stresses do not exceed a value of 550 Pa.

25. The apparatus as defined in claim 23, wherein the blocks of the fire-resistant material are arranged so that joints (603, 703, 704) between said blocks are not in regions in which the at least one stirrer blade (210) approaches closely to the wall (130) and the base (132).

26. The apparatus as defined in claim 22, further comprising a base outlet under the at least one stirrer (202, 204; 302, 304; 408, 410; 508, 510).

27. The apparatus as defined in claim 22, wherein the stirring device (110, 406) has at least two stirrers (202, 204; 302, 304; 408, 410; 508, 510) arranged in series or following each other in the throughput flow direction (206).

28. The apparatus as defined in claim 22, wherein the stirring device (110, 4060 has at least two stirrers (202, 204; 302, 304; 408, 410; 508, 510) arranged next to each other transverse to the throughput flow direction (206), whose common axial feed action is greater than that in the throughput flow direction (206).

29. The apparatus as defined in claim 22, further comprising a wall (130) and/or a base (132) of the first connecting part 400), of a stirring device (140, 406), and/or of the second connecting part (120, 420), and at least one barrier element (216, 218, 220) arranged along the wall (130) and/or the base (130).

30. The apparatus as defined in claim 22, wherein the stirring device has a wall that forms a stirring vessel (404, 414, 504, 515), which is arranged at least approximately concentric to a peripheral section of the at least one stirrer (202, 204; 302, 304; 408, 410; 508, 510).

31. The apparatus as defined in claim 30, wherein the stirring vessel has a polygonal base area.

32. The apparatus as defined in claim 31, wherein the polygonal base area is hexagonal or octagonal.

33. The apparatus as defined in claim 15, further comprising a spout made of the fire-resistant material, which connects to the second connecting part (120, 420) downstream thereof.

34. A method of using the apparatus as defined in claim 15 to make display glass.
